(19) United States
(12) Patent Application Publication
(10) Pub. No.: US 2004/0037284 A1
(43) Pub. Date: Feb. 26, 2004

(54) Method for secure packet-based communication between two units via an intermedia unit

(76) Inventors: Martin Bergek, SE-412 (SE); Mats Hojlund, SE-431 (SE)

Correspondence Address: HARNESS, DICKEY & PIERCE, P.L.C., P.O. BOX 8910, RESTON, VA, 20195, US

(21) Appl. No.: 10/416,201

(22) PCT Filed: Nov. 8, 2001
(86) PCT No.: PCT/SE01/02462

(30) Foreign Application Priority Data
Nov. 8, 2000 (SE) 0004076-6

(51) Int. Cl. H04L 12/28

(52) U.S. Cl. 370/392; 370/466

(57) ABSTRACT

A method and system for packet based data communication between a first unit (1) and a second unit (3), wherein said first unit (1) communicate via an intermediate unit (2), each unit being identified by at least one address. The method comprises the steps of retrieving, at said first unit (1), from said intermediate unit (2) and address of said at least one address identifying said intermediate unit. The retrieved address is used as source address when forming a first data packet in said first unit (1). The data packet is tunneled from said first unit (1) to said intermediate unit (2) and then sent from said intermediate unit to said second unit.

### FIELD OF INVENTION

The present invention relates to a method and a system for transmitting data packets between different units.

### BACKGROUND OF THE INVENTION

With the introduction of packet based communication systems such as GPRS, EDGE and WCDMA, new ways of securely connecting to corporate and other networks need to be devised. Presently, connecting to a corporate network is commonly solved by using a dial-up connection over a regular circuit-switched telephone network in order to solve the security problems arising when accessing the network via a packet-based network.

The issues that need to be addressed in any security scheme are:

Authentication—the system the user connects to must be certain that the user is authenticated to disallow anyone other than privileged users.

Encryption—the information that is communicated must be kept secure from anyone with the ability to eavesdrop on the data.

Data integrity—the data must not be changed while in transit.

When dialling into a modem pool on the corporate network these issues can be somewhat relaxed since the information is never transported on a public network, granted that the circuit-switched telephone network operator is a trusted party. However, some sort of authentication is mostly performed, such as supplying a user password, one-time password, etc when logging in.

When the connection method is changed to packet-based networks, such as networks using TCP/IP, new ways of solving security are needed. It is quite possible, and indeed even likely, that the data traffic to a large extent will be transported via the Internet. This is especially true to upcoming mobile standards. Here the mobile network might even be connected to the Internet at a single point.

With this in mind, new efforts must be placed on solving the encryption and integrity issues. One way of solving this is through the use of standardised security solutions such as IPSec, a security add-on to the Internet protocol that adds functions for solving authentication, encryption and data integrity. IPSec is one version of a family of solutions called VPN—Virtual Private Networks. They all work in a similar manner and tunnels data over an insecure network. The user's computer is located at one end of the tunnel, while the other end of the tunnel is located on another network, usually on a secure network behind a firewall. For simplicity this document will focus on IPSec, although the problem and its solution equally well applies to other tunnelling solutions.

IPSec, or other similiar solutions, can be implemented in a number of different ways. One way is to implement an entire new TCP/IP stack. However, this is costly and means that the entire function of the stack needs to be re-implemented instead of simply being reused.

Another way is using a “Bump in the stack” (BITS) solution. BITS is a method whereby the security solutions, such as IPSec, are placed just below the TCP/IP stack, i.e. between the network and data link layer. Such a solution is done in software and does not require a complete rewriting of the TCP/IP stack. The IPSec client is located below the TCP/IP stack and tunnels the data to and from an IPSec server at the other end.

Yet another way is using a “Bump in the Wire” (BITW) solution. BITW is the same as BITS, except the implementation is done for the actual transmission medium, i.e. in the data link or physcial layer of the network. The IPSec client is then located on the actual communication link and tunnels the data to and from the IPSec server at the other end. Based on both practical and economical reasons, BITS is likely to be the most commonly used method to implement IPSec.

There are several problems with using solutions with authentication, encryption and/or data integrity checks implemented between the network layer, i.e. a TCP/IP stack, and the data link and physical layers. IPSec places severe constraints on the possibilities of changing data as it is passed over the network. This makes it impossible to change IP packet headers while in transit.

There are a number of situations when IP packets need to be changed while in transit. One situation is when a NAT (Network Address Translation) solution is needed to limit the use of IP addresses. The IP address used externally by the NAT-gateway for a specific client computer may change without notice. A GPRS network with numerous attached terminals is a typical case for a NAT solution since there are not enough individual IP addresses for all terminals. Instead the addresses are shared among multiple terminals. One IP address does not therefore necessarily identify one specific client.

Another situation is when using Mobile IP. Mobile IP works in a way that makes it unsuitable together with security solutions.

Yet another situation is present in systems using multiple simultaneous packet-based communication links, such as the system described in the PCT-application SE00/00883 to Karlsson et al. In such a system technology is used that increases the bandwidth for mobile data communication by enabling the use of multiple simultaneous packet-based communication links. This means that the client computer will be associated with multiple IP addresses, which may be assigned dynamically depending of the underlying communication technology.

Normally the IPSec client would use the IP address of the client and encrypt that address together with the payload. The IPSec gateway, i.e. the recipient, would then decrypt the data and authenticate the data. As a vital part in that process it checks the sender's address and compares it with information in the encrypted payload. In the normal case the IPSec client would have got its IP address from the network layer of the client and no discrepancy would exist. Consequently the IP packet would be accepted by the IPSec gateway and be forwarded to its destination.

If, on the other hand, the packet was changed, to accommodate to one of the situations above, such as a NAT solution or any other solution that changes the IP packets, the sender's IP address, as seen by the IPSec gateway, would differ from the encrypted information. This discrepancy would make the packets be discarded by the IPSec gateway. Clearly, this is not the desired behaviour.

Problems occuring when implementing a security solution in a TCP/IP environment have now been described as an example. More generally, the problem relates to packet based communication systems, wherein data is transported from a first unit to a second unit, and the data is sent through an intermediate unit. Thus, in other solutions where data is to be transported through an intermediate unit, these problems are likely to occur, since for the receiving unit, it appears that data really is sent from the intermediate unit, where it in fact originates from a unit behind the intermediate unit. In other words, the problem occurs in end-to-end security solutions where an intermediate unit performs changes to the transferred data.

### OBJECT OF THE INVENTION

It is therefore an object of the present invention to provide an improved method and system for data packet communication from a first unit to a second unit, where the data packets are sent through an intermediate unit, which allows implementation of solutions securing data transfer from the source to the destination, overcoming the above mentioned problems.

The object is achieved by a method and a system according to the appended claims.

### SUMMARY OF THE INVENTION

According to the invention a method for packet based data communication between a first unit and a second unit, wherein said first unit communicate via an intermediate unit, each unit being identified by at least one address, comprises the steps of: retrieving, at said first unit, from said intermediate unit an address of said at least one address identifying said intermediate unit; using said retrieved address as source address when forming a first data packet in said first unit; sending said first data packet from said first unit to said intermediate unit; and forwarding said first data packet from said intermediate unit to said second unit using said retrieved address.

Hereby a method is provided overcoming the above-mentioned problems. The method according to the invention thus utilizes data packets having an address of the intermediate unit as source address. Then, it looks like the packets being sent from the first unit actually are sent from the intermediate unit. The term “address” used should be interpreted broadly, as a sort of identification of each unit. The units above could be any type of computational device with communication means, such as a mobile terminal, a personal computer with a network card, etc. The inventive method provides new possibilities when implementing solutions securing data transfer from the first unit to the second unit. Such solutions could then be implemented in the first and second unit regardless of any intermediate unit. Thus, this new way of sending data packets through a intermediate unit, provides possibilities to utilize security solutions in the first and second unit without adapting them to a communication solution with an intermediate unit.

For example, with such a method it becomes feasible to use solutions for authentication, encryption and/or data integrity checks for data packets sent through an intermediate unit, for example a NAT-gateway, a foreign agent in a mobile IP solution or such a solution for increased bandwidth described above.

Preferably, the step of sending said first data packet from said first unit to said intermediate unit comprises the sub-steps of: encapsulating, at said first unit, said first data packet into a new data packet having one of said at least one address identifying said first unit as source address; sending said new data packet from said first unit to said intermediate unit; and decapsulating, at said intermediate unit, said new data packet in order to obtain said first data packet in original form. Hereby, a tunnel is provided between the first unit and the intermediate unit in order to transport the data packets with addresses other than the address of the first unit.

Said first unit is advantageously described in layers, where it comprises an application layer, a transport/network layer, a data link and a physical layer. An adapter is provided in the network layer for handling a physical communication device in the layers beneath. In some applications the first unit could have several adapters. An adapter could for example be a network card, a wireless connection device utilizing bluetooth, etc. As previously has been described, the method according to the present invention is applicable when using a security solution implemented above the adapters, but below the application layer, i.e. a security protocol implemented as a BITS solution or implemented in a rewritten stack.

Preferably, the step of retrieving an address from the intermediate unit is then performed in a function just above the adapters. A function in the transport/network layer requesting an address from an adapter, would then be responded with an address other than the address of the adapter.

Then a request from the application layer to the transport layer for transporting data would result in a data packet having an source address other than an address of one of the unit's adapters.

In a preferred embodiment the address which is retrieved from the intermediate unit is reserved at the intermediate unit. This is useful embodiments where there are several units which send data through the intermediate unit. Reservation is done in order to prevent other sending units using the intermediate unit from simultaneously using the same address in their data packets. Utilizing reserved addresses at the intermediate unit are also of interest when resolving replies to the sent data packet, i.e. for routing data packets back to the first unit. However, there are other' solutions to determine which address a first unit should use at the intermediate unit. For example, this could be determined at an earlier stage, since the first unit and the intermediate unit probably has some sort of relation before the address is retrieved. This relation could for example be a NAT-solution or a system using multiple simultaneous packet-based communication links, such as the system described in the PCT-application SE00/00883 to Karlsson et al, wherein the first unit would represent a client and the intermediate unit a NAT-gateway and server, respectively. Another way would be to use a static predetermined address at the intermediate unit for the first unit. Preferably, the reservation is temporary and lasts for a specified time period. For example, the reservation could use a time out function, i.e. if the first unit does not sent or receive any data packets through the intermediate unit during a specified time interval, the reservation expires. However, in another. embodiment it is possible to share an address at the intermediate unit among several units utilizing the intermediate unit for sending data. Then, some sort of resolution of the replies to data packets being sent would have to be implemented. One such solution could be based on the contents and/or the destination and/or the time the packet was sent.

Preferably the method according to the present invention comprises the further step of: applying, at said first unit, security information based on said retrieved address to said first data packet. Hereby, security can be applied at the first unit, even though the second unit will see the intermediate unit as the sending unit. Thus, a secure tunnel is provided outside the tunnel all the way from the first unit to the second unit. It will by this method become possible to agree upon security solutions without getting in touch with an operator of the intermediate unit. The security information could comprise an authentication header which contains a authentication data verifying the integrity of the data packet, but could also comprise data signing and/or encryption. This secure tunnel is preferably implemented using the IPSec protocol. In this embodiment, the method also comprises the step of verifying, at said second unit, the data and transport information of said first data packet using said applied security information. Hereby, the integrity of the data is checked so that no disallowed changes has been done while the data was in transit. Thus, the security information could be added in the first unit and verified in the second unit, without regards to the intermediate unit since the retrieved address is used as source address in the data packet. This allows standard solutions for data security to be used, such as IPSec.

In one embodiment, the method comprises the further steps of: sending a second data packet from said second unit to said intermediate unit, said second data packet having an address of said at least one address identifying said intermediate unit as destination address; and tunneling said second data packet from said intermediate unit to said first unit.

Hereby, a method is provided which handles also replies from the second unit to the first unit. With such a method it is feasible to use the same security solution when sending a reply to the data packet sent from the second unit. Thus, the second unit does not need any additional software for replying to the first data packet. When security information is added by the second unit, such as the information added by IPSec if IPSec is used, this information is thus based on an address of the second unit as source address and an address of the intermediate unit as destination address. Then in order to transport the packet to the first unit it is encapsulated in a packet and transmitted to one of the at least one adapter of the first unit where it is decapsulated. Since the first unit initially retrieved an address from the intermediate unit to use for its data packets, the packet will be verified against this retrieved address resulting in a successful verification of the security information.

Also according to the invention a system for transmitting at least one data packet from a first unit to a second unit, wherein said first unit communicate via an intermediate unit, each unit having at least one address, comprising: means at said first unit for retrieving from said intermediate unit an address of said at least one address identifying said intermediate unit, means at said first unit for using said retrieved address as source address when forming a first data packet in said first unit; means for sending said first data packet from said first unit to said intermediate unit; and means at said intermediate unit for forwarding said first data packet from said intermediate unit to said second unit using said retrieved address. Preferably, the means for sending said first data packet from said first unit to said intermediate unit comprises: means for encapsulating, at said first unit, said first data packet into a new data packet having one of said at least one address identifying said first unit as source address; means for sending said new data packet from said first unit to said intermediate unit; and means for decapsulating, at said intermediate unit, said new data packet in order to obtain said first data packet in original form.

Hereby a system is provided overcoming the above-mentioned problems. The advantages of the system corresponds to those of the method according to the invention.

### BRIEF DESCRIPTION OF THE DRAWINGS

For exemplifying purposes, the invention will be described to embodiments thereof illustrated in the attached drawings, wherein:

FIG. 1 is a schematic view of a system according to an embodiment of the invention; and

FIG. 2 is a flow-chart illustrating a method according to an embodiment of the invention.

### DESCRIPTION OF PREFERRED EMBODIMENTS

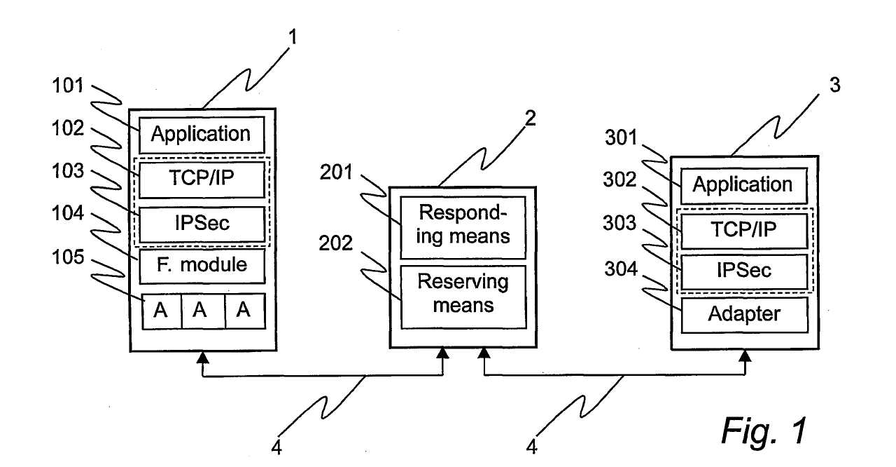

The inventive method is a method for packet based data communication between a first unit 1 and a second unit 3. The method is applicable when the first unit 1 uses an intermediate unit 2 for communicating with other units, such as the second unit 3. The units above could be any type of computational device with communication means, such as a mobile terminal, a personal computer with a network card, etc. The units communicate via a network 4, which could be a LAN, the Internet, a wireless LAN, etc. or any combination of different network types. These components are illustrated in FIG. 1. This embodiment will now be described in a TCP/IP environment, however a person skilled in the art will appreciate that the method is applicable in any packet based network environment. In a preferred embodiment of the invention a first unit comprises a TCP/IP stack 102, one or more adapters 105 and a IPSec module 103. The IPSec module 103 is located between the TCP/IP stack 102 and the adapters, i.e. a BITS solution. The IPSec module 103 can be used for adding authentication, encryption and/or signing to the data to achieve the desired security. In another embodiment, the TCP/IP stack and the IPSec module can be implemented in the same module/component, indicated by the dotted line in FIG. 1.

Preferably the parts of the method according to the present invention are implemented in a functional module 104 located between the IPSec client 103 and the adapters 105. The functional module would then provide means for retrieving an IP address from the intermediate unit. As the functional module 104 is located between the TCP/IP stack 102 and the adapters 105 it can intercept the requests from the TCP/IP stack for an IP address. The TCP/IP address would then be provided by the functional module 104 and not an adapter 105.

Since the functional module 104 will provide an IP address retrieved from the intermediate unit 2, the data packets created in the TCP/IP stack will have this address as their source address. Thus, the functional module 104 will appear as an adapter to the IPSec module 103 and the TCP/IP stack 102.

The functional module 104 would then also provide means for sending the data packet created in the TCP/IP stack 102 using an adapter 105 of the first unit 1. This would preferably be done by tunneling the data packet in another data packet. The tunneling comprises activities like encapsulation and decapsulation. The encapsulated data packet would then have the actual IP address of an adapter 105 of the first unit 1.

Most likely, the intermediate unit 2 is a NAT-server, a server used in a system with multiple communication links for reassembling data packets, a foreign agent in a mobile IP solution, etc. Thus, it is also likely that the intermediate unit 2 is serving several first units 1. The intermediate unit 2 of a preferred embodiment comprises responding means 201 for responding to requests for IP addresses from a first unit 1. In order to handle multiple first units, the intermediate unit 2 preferably comprises reservation means 202 for reserving an IP address to a particular first unit. In such an embodiment the intermediate unit has a plurality of IP addresses for usage with different connecting first units 1. When replies to data packets sent are received, these are routed to the first unit which sent the corresponding data packet. Since the intermediate unit has a plurality of IP addresses it has a module responding to all the corresponding ARP packets broadcasted on the intermediate unit's sub-net.

The second unit 3 could be any unit which the first unit 1 communicates with and forms a part of the environment where the invention is applicable. The second unit 3 could as the first unit be any kind of computational means having a communication device, such as a personal computer with a network card. Like the first unit 1, the second unit comprise in this embodiment an application layer 301, a TCP/IP stack 302, an IPSec module 303 and one or more adapters 305. In another embodiment, the TCP/IP stack 302 and IPSec module 303 could be implemented in the same module, indicated by the dotted line in FIG. 1. In order to provide a secure transfer of data packets from the first unit 1 to the second unit 3, the IPSec module 103 adds security by adding encryption, authentication information, and signing according to the IPSec protocol. This is then resolved by a corresponding IPSec module 303 in the second unit upon receiving. Since the data packets created by the TCP/IP stack 102 in the first unit 1 are tunneled to the intermediate unit 2 where they are decapsulated, they appear to the second unit 3 as being sent by the intermediate unit 2.

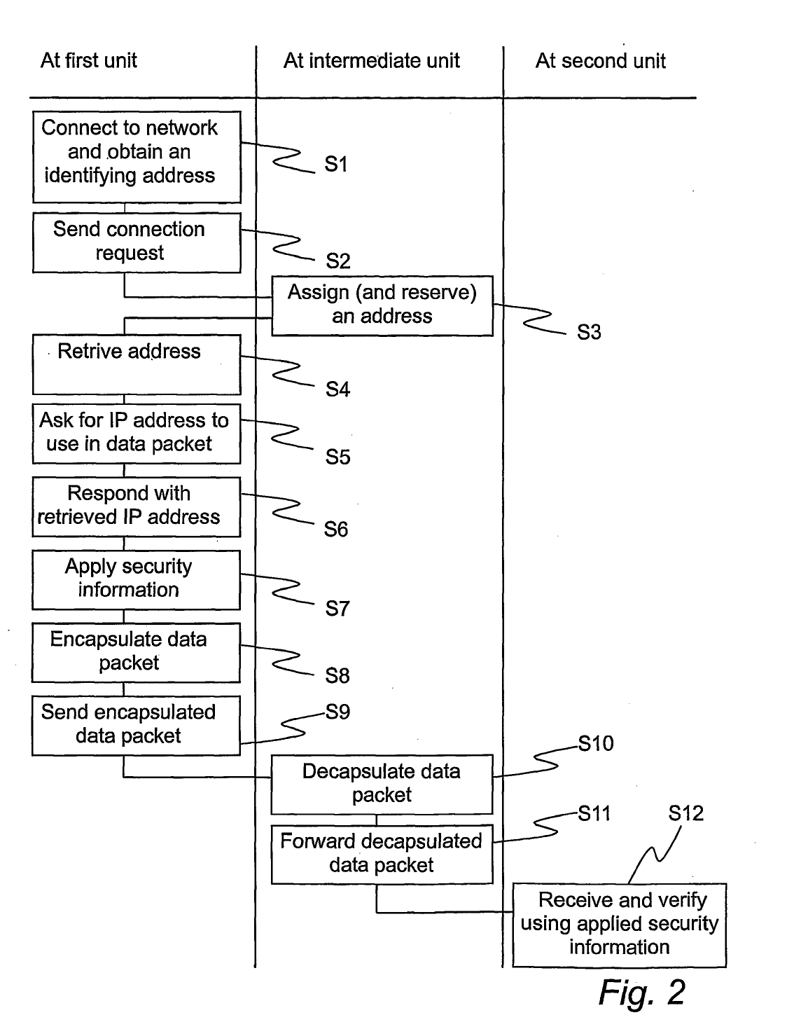

Now the steps of a method according to an embodiment of the invention will be described with reference to FIG. 2. In the initial state the first unit is not connected to a network. In a step S1 the first unit connects to the network with one of its communication devices, i.e. adapters. If an adapter does not have a fixed IP address, this has to be provided by the network. The IP address could for example be obtained using the BOOTP or the DHCP protocol.

In a step S2 the first unit sends a connection request to the intermediate unit, which request preferably contain information about the adapters of the first unit, such as their IP addresses, and an identification of the first unit. Preferably, some sort of authentication is also included in the connection request, such a login and password.

In a step S3, the intermediate unit assigns, and preferably reserves, one of its IP addresses to the first unit as a response to the connection request. The assignment could follow a scheme based on the first units identity or be assigned dynamically. In order to keep track of all assignments, these could be stored in a list, database or the like.

This assigned address is retrieved by the first unit in a step S4. A communication request from the application to the TCP/IP stack of the first unit will result in the TCP/IP stack forming data packets to be sent using the adapters. In a step S5, the TCP/IP stack will then ask an adapter for its IP address. The adapter will then be the functional module 104, which in a step S6 will respond with the IP address retrieved from the intermediate unit 2.

Then, in a step S7, security information, such as an authentication header, encryption and/or a digital signature is applied to the data packet created by the TCP/IP stack 102 in the IPSec module 104. This new data packet will passed down to the adapter, as the IPSec module perceives it, i.e. the functional module 104. The functional module will then in a step S8 encapsulate the data packet and in a step S9 send it using one or more if the adapters 105 to the intermediate unit 2.

The intermediate unit will in a step S10 decapsulate the data packet and in a step S11 send it to the destination address in the data packet. In a step S12, the data packet is received by the second unit 3 and the data packet will be verified using the security information applied in the first unit. It could be authenticated, decrypted and/or verified with regards to any digital signature.

The invention has been described above in terms of a preferred embodiment. However, the scope of this invention should not be limited by this embodiment, and alternative embodiments of the invention are feasible, as should be appreciated by a person skilled in the art. For example, the security protocol does not need to be IPSec, since the problem will occur with any similar VPN-solution. Such embodiments should be considered to be within the scope of the invention, as it is defined by the appended claims.

1. A method for packet based data communication between a first unit (1) and a second unit (3), wherein said first unit (1) communicate via an intermediate unit (2), each unit being identified by at least one address, comprising the steps of:
retrieving, at said first unit (1), from said intermediate unit (2) an address of said at least one address identifying said intermediate unit;
using said retrieved address as source address when forming a first data packet in said first unit (1);
sending said first data packet from said first unit (1) to said intermediate unit (2); and
forwarding said first data packet from said intermediate unit to said second unit using said retrieved address,
wherein the step of sending said first data packet from said first unit (1) to said intermediate unit (2) comprises the sub-steps of:
encapsulating, at said first unit (1), said first data packet into a new data packet having one of said at least one address identifying said first unit as source address;
sending said new data packet from said first unit (1) to said intermediate unit (2); and
decapsulating, at said intermediate unit (2), said new data packet in order to obtain said first data packet in original form.

2. A method according to claim 1, further comprising the step of:
reserving said retrieved address at said intermediate unit.

3. A method according to claim 2, wherein said reservation is temporarily and lasts for a specified time period.

4. A method according to any of the preceding claims, comprising the further step of:
applying, at said first unit (1), security information based on said retrieved address to said first data packet.

5. A method according to claim 4, comprising the further step of:
verifying, at said second unit (3), the data and transport information of said first data packet using said security information.

6. A method according to claim 4 or 5, wherein the added security information is an authentication header.

7. A method according to any of the preceding claims, where in the data packets are transported and formed according to the TCP/IP protocol.

8. A method according to claim 7 as appendant on claim 4, wherein said security information is applied using the IPSec protocol.

9. A method according to any of the preceding claims, further comprising the steps of:
sending a second data packet from said second unit to said intermediate unit, said second data packet having an address of said at least one address identifying said intermediate unit as destination address; and
tunneling said second data packet from said intermediate unit to said first unit.

10. A system for transmitting at least one data packet from a first unit (1) to a second unit (3), wherein said first unit (1) communicate via an intermediate unit (2), each unit having at least one address, comprising:
means at said first unit (1) for retrieving from said intermediate unit (2) an address of said at least one address identifying said intermediate unit (2),
means at said first unit (1) for using said retrieved address as source address when forming a first data packet in said first unit (1);
means for sending said first data packet from said first unit (1) to said intermediate unit (2); and
means at said intermediate (2) unit for forwarding said first data packet from said intermediate unit (2) to said second unit (3) using said retrieved address;
wherein said means for sending said first data packet from said first unit (1) to said intermediate unit (2) comprises:
means for encapsulating, at said first unit (1), said first data packet into a new data packet having one of said at least one address identifying said first unit as source address;
means for sending said new data packet from said first unit (1) to said intermediate unit (2); and
and means for decapsulating, at said intermediate unit (2), said new data packet in order to obtain said first data packet in original form.

11. A system according to claim 10, comprising means, at said first unit (1), for applying security information based on said retrieved address to said first data packet.

12. A system according to claim 10 or 11, wherein said first unit comprises an adapter for handling a physical communication device and a network stack, where the means for retrieving and sending at said first unit operates between said network stack and said adapter.
